(19) United States
(12) Patent Application Publication
(10) Pub. No.: US 2018/0146191 A1
(43) Pub. Date: May 24, 2018

(54) System and Method for Coding Intra Prediction Mode using a Second Set of Most Probable Modes

(71) Applicants: FutureWei Technologies, Inc., Plano, TX (US); Santa Clara University, Santa Clara, CA (US)

(72) Inventors: Minqiang Jiang, Campbell, CA (US); Jianhua Zheng, Beijing (CN); Promila Agarwal, Milpitas, CA (US); Michael Schimpf, Santa Clara, CA (US); Nam Ling, San Jose, CA (US); Chen-Xiong Zhang, Plano, TX (US)

(21) Appl. No.: 15/818,551

(22) Filed: Nov. 20, 2017

Related U.S. Application Data
(60) Provisional application No. 62/425,425, filed on Nov. 22, 2016.

(51) Int. Cl. H04N 19/105; H04N 19/593

(52) U.S. Cl. CPC H04N 19/105; H04N 19/176; H04N 19/593

(57) ABSTRACT

Embodiment methods generate a second set of most probable modes (MPMs) from a plurality of intra prediction modes excluding a first set of MPMs for intra prediction or reconstruction of a luma block. An embodiment method constructs a reference block of the luma block, selects a number of samples in the reference block that have been predicted or reconstructed but not in the luma block, and performs intra prediction (or reconstruction) of the selected samples using each of some or all of the plurality of intra prediction modes excluding the first set of MPMs, thereby generating predicted samples (or reconstructed samples) for the selected samples. Based on the predicted samples (or reconstructed samples) and the selected samples, the second set MPM is selected.

This patent application claims priority to U.S. Provisional Application No. 62/425,425, filed on Nov. 22, 2016 and entitled “System and Method for Coding Intra Prediction Mode using a Second Set of Most Probable Modes,” which is hereby incorporated by reference herein as if reproduced in its entirety.

### TECHNICAL FIELD

The present disclosure relates to a system and method for video coding, and, in particular embodiments, to a system and method for coding intra prediction mode using a second set of most probable modes.

### BACKGROUND

High Efficiency Video Coding (HEVC) is a video coding standard developed by the Joint Collaborative Team on Video Coding (JCT-VC). HEVC supports 35 intra prediction modes including DC, planar and 33 angular modes.

### SUMMARY

Technical advantages are generally achieved, by embodiments of this disclosure which describe a system and method for coding intra prediction mode using a second set of most probable modes.

According to one aspect of the present disclosure, there is provided a method that includes: selecting, by an encoder, a second set of most probable modes (MPMs) in a plurality of intra prediction modes for intra prediction of a luma block of a video frame, the second set of MPMs comprising a predetermined number of intra prediction modes in the plurality of intra prediction modes excluding a first set of MPMs in the plurality of intra prediction modes, wherein the second set of MPMs is derived by: constructing a first reference block of the luma block, each of the first reference block and the luma block comprising a plurality of samples, and the first reference block being different from the luma block; determining a first set of samples in the first reference block, the first set of samples excluding samples in the luma block and having been predicted; calculating a prediction error for performing intra prediction of the first set of samples using each of two or more intra prediction modes in the plurality of intra prediction modes excluding the first set of MPMs, thereby generating a first plurality of prediction errors corresponding to the two or more intra prediction modes, each of the first plurality of prediction errors being associated with a corresponding intra prediction mode; and selecting the second set of MPMs based on the first plurality of prediction errors.

According to another aspect of the present disclosure, there is provided a video processing device that includes: a non-transitory memory storage comprising instructions; and one or more processors in communication with the memory storage, wherein the one or more processors execute the instructions to: select a second set of most probable modes (MPMs) in a plurality of intra prediction modes for intra prediction of a luma block of a video frame, the second set of MPMs comprising a predetermined number of intra prediction modes in the plurality of intra prediction modes excluding a first set of MPMs in the plurality of intra prediction modes, wherein the second set of MPMs is derived by: constructing a first reference block of the luma block, each of the first reference block and the luma block comprising a plurality of samples, and the first reference block being different from the luma block; determining a first set of samples in the first reference block, the first set of samples excluding samples in the luma block and having been predicted; calculating a prediction error for performing intra prediction of the first set of samples using each of two or more intra prediction modes in the plurality of intra prediction modes excluding the first set of MPMs, thereby generating a first plurality of prediction errors corresponding to the two or more intra prediction modes, each of the first plurality of prediction errors being associated with a corresponding intra prediction mode; and selecting the second set of MPMs based on the first plurality of prediction errors

Optionally, in any of the preceding aspects, the method further includes: deriving the first set of MPMs based on a high efficiency video coding (HEVC) standard.

Optionally, in any of the preceding aspects, the method further includes: signaling, by the encoder, a first indication indicating that the second set of MPMs is selected for intra prediction of the luma block; and signaling, by the encoder, a second indication indicating a selected intra prediction mode in the second set of MPMs.

Optionally, in any of the preceding aspects, the second set of MPMs is selected when the first set of MPMs is not selected for intra prediction of the luma block.

Optionally, in any of the preceding aspects, the second set of MPMs is further derived by: constructing a second reference block of the luma block that is different from the first reference block; determining a second set of samples in the second reference block, the second set of samples excluding the samples in the luma block and having been predicted; and calculating a prediction error for performing intra prediction of the second set of samples using each of two or more intra prediction modes in the plurality of intra prediction modes excluding the first set of MPMs, thereby generating a second plurality of prediction errors corresponding to the two or more intra prediction modes; and wherein selecting the second set of MPMs comprises selecting the second set of MPMs from the plurality of intra prediction modes excluding the first set of MPMs based on the first plurality of prediction errors and the second plurality of prediction errors.

Optionally, in any of the preceding aspects, calculating the prediction error for performing intra prediction of the first set of samples using each of the two or more intra prediction modes in the plurality of intra prediction modes excluding the first set of MPMs comprises: determining a set of neighboring reference samples for the first reference block; generating predicted samples of the first set of samples using the set of neighboring reference samples in accordance with a respective intra prediction mode; and calculating a respective prediction error corresponding to the respective intra prediction mode based on the first set of samples and the predicted samples.

Optionally, in any of the preceding aspects, calculating the respective prediction error comprises calculating a sum of absolute difference (SAD) of the first set of samples and the predicted samples.

Optionally, in any of the preceding aspects, calculating the respective prediction error comprises calculating a sum of squared difference (SSD) of the first set of samples and the predicted samples.

Optionally, in any of the preceding aspects, selecting the second set of MPMs based on the first plurality of prediction errors comprises: sorting the first plurality of prediction errors in an ascending order; and selecting one or more intra prediction modes associated with prediction errors that satisfy a criterion.

Optionally, in any of the preceding aspects, the second set of MPMs comprises four intra prediction modes.

Optionally, in any of the preceding aspects, calculating the prediction error comprises calculating the prediction error for performing intra prediction of the first set of samples using each of the plurality of intra prediction modes excluding the first set of MPMs.

According to yet another aspect of the present disclosure, there is provided a method that includes: receiving, by a decoder, an indication indicating a selected intra prediction mode in a second set of most probable modes (MPMs) for reconstructing a luma block, the second set of MPMs comprising a predetermined number of intra prediction modes in a plurality of intra prediction modes excluding a first set of MPMs in the plurality of intra prediction modes; and reconstructing the luma block using the selected intra prediction mode.

According to yet another aspect of the present disclosure, there is provided a video processing device that includes: a non-transitory memory storage comprising instructions; and one or more processors in communication with the memory storage, wherein the one or more processors execute the instructions to: receive indication indicating a selected intra prediction mode in a second set of most probable modes (MPMs) for reconstructing a luma block, the second set of MPMs comprising a predetermined number of intra prediction modes in a plurality of intra prediction modes excluding a first set of MPMs in the plurality of intra prediction modes; and reconstruct the luma block using the selected intra prediction mode.

Optionally, in any of the preceding aspects, the first set of MPMs is determined based on a high efficiency video coding (HEVC) standard.

According to yet another aspect of the present disclosure, there is provided a method that includes: selecting, by a decoder, a second set of most probable modes (MPMs) in a plurality of intra prediction modes for reconstructing a luma block of a frame, the second set of MPMs comprising a predetermined number of intra prediction modes in the plurality of intra prediction modes excluding a first set of MPMs in the plurality of intra prediction modes, wherein the second set of MPMs is derived by: constructing a first reference block of the luma block, each of the first reference block and the luma block comprising a plurality of samples; determining a first set of samples in the first reference block, the first set of samples excluding samples in the luma block and having been reconstructed; calculating a reconstruction error for reconstructing the first set of samples using each of two or more intra prediction modes in the plurality of intra prediction modes excluding the first set of MPMs, thereby generating a first plurality of reconstruction errors corresponding to the two or more intra prediction modes, each of the first plurality of reconstruction errors being associated with a corresponding intra prediction mode; and selecting the second set of MPMs based on the first plurality of reconstruction errors.

According to yet another aspect of the present disclosure, there is provided a video processing device that includes: a non-transitory memory storage comprising instructions; and one or more processors in communication with the memory storage, wherein the one or more processors execute the instructions to: select a second set of most probable modes (MPMs) in a plurality of intra prediction modes for reconstructing a luma block of a frame, the second set of MPMs comprising a predetermined number of intra prediction modes in the plurality of intra prediction modes excluding a first set of MPMs in the plurality of intra prediction modes, wherein the second set of MPMs is derived by: constructing a first reference block of the luma block, each of the first reference block and the luma block comprising a plurality of samples; determining a first set of samples in the first reference block, the first set of samples excluding samples in the luma block and having been reconstructed; calculating a reconstruction error for reconstructing the first set of samples using each of two or more intra prediction modes in the plurality of intra prediction modes excluding the first set of MPMs, thereby generating a first plurality of reconstruction errors corresponding to the two or more intra prediction modes, each of the first plurality of reconstruction errors being associated with a corresponding intra prediction mode; and selecting the second set of MPMs based on the first plurality of reconstruction errors.

Optionally, in any of the preceding aspects, the method further includes: receiving, by the decoder, an indication indicating that the second set of MPMs is selected for intra prediction of the luma block.

Optionally, in any of the preceding aspects, the second set of MPMs is further derived by: constructing a second reference block of the luma block that is different from the first reference block; determining a second set of samples in the second reference block, the second set of samples excluding the samples in the luma block and having been reconstructed; and calculating a reconstruction error for reconstructing the second set of samples using each of two or more intra prediction modes in the plurality of intra prediction modes excluding the first set of MPMs, thereby generating a second plurality of reconstruction errors corresponding to the two or more intra prediction modes; and wherein selecting the second set of MPMs comprises selecting the second set of MPMs from the plurality of intra prediction modes excluding the first set of MPMs based on the first plurality of reconstruction errors and the second plurality of reconstruction errors.

Optionally, in any of the preceding aspects, calculating the reconstruction error for reconstructing the first set of samples using each of the two or more intra prediction modes in the plurality of intra prediction modes excluding the first set of MPMs comprises: determining a set of neighboring reference samples for the first reference block; generating reconstructed samples of the first set of samples using the set of neighboring reference samples in accordance with a respective intra prediction mode; and calculating a respective reconstruction error corresponding to the respective intra prediction mode based on the first set of samples and the reconstructed samples.

Optionally, in any of the preceding aspects, calculating the respective reconstruction error comprises calculating a sum of absolute difference (SAD) of the first set of samples and the reconstructed samples.

Optionally, in any of the preceding aspects, calculating the respective reconstruction error comprises calculating a sum of squared difference (SSD) of the first set of samples and the reconstructed samples.

Optionally, in any of the preceding aspects, selecting the second set of MPMs based on the first plurality of reconstruction errors comprises: sorting the first plurality of reconstruction errors in an ascending order; and selecting one or more intra prediction modes associated with reconstruction errors that satisfy a criterion.

Optionally, in any of the preceding aspects, the second set of MPMs comprises four intra prediction modes.

Optionally, in any of the preceding aspects, calculating the reconstruction error comprises calculating the reconstruction error for reconstructing the first set of samples using each of the plurality of intra prediction modes excluding the first set of MPMs.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates a diagram of an embodiment video frame;

FIG. 2 illustrates a flowchart of an embodiment method for deriving a second set most probable mode (MPM);

FIG. 3 illustrates a diagram of another embodiment video frame;

FIG. 4 illustrates a flowchart of an embodiment method for determining an intra prediction mode for a luma block;

FIG. 5 is a table illustrating BD-rate performance obtained using an embodiment method;

FIG. 6 is another table illustrating BD-rate performance obtained using an embodiment method;

FIG. 7 illustrates a flowchart of an embodiment intra prediction method;

FIG. 8 illustrates a flowchart of an embodiment method for decoding a luma block;

FIG. 9 illustrates a flowchart of another embodiment method for decoding a luma block;

FIG. 10 illustrates a diagram of yet another embodiment video frame;

FIG. 11 illustrates a diagram of yet another embodiment video frame;

FIG. 12 illustrates a flowchart of another embodiment intra prediction method;

FIG. 13 illustrates a block diagram of an embodiment processing system; and

FIG. 14 illustrates a block diagram of an embodiment transceiver.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

HEVC utilizes 35 intra prediction modes for prediction of a luma block. HEVC defines a set of three most probable modes (MPMs) for a luma block based on prediction modes of two neighbor blocks of the luma block. The set of three MPMs defined in HEVC may be referred to as the first set MPM that include three intra prediction modes in the 35 intra prediction modes. If an intra prediction mode selected for the luma block is not one of its three most probable modes, the luma block is coded as one of the remaining intra prediction modes.

Embodiments of the disclosure provide methods that derive a second set of most probable modes, in addition to the first set MPM, for intra prediction of a luma block. The second set of most probable modes may be referred to as the second set MPM. The second set MPM may include a number of intra prediction modes selected from a plurality of available intra prediction modes excluding the first set MPM. In an embodiment method for deriving the second set MPM for a luma block, a reference block may be constructed that may have the same size as the luma block. The reference block includes one or more samples that are not in the luma block and that have been predicted or reconstructed. The reference block may also include one or more samples of the luma block. The embodiment method may select a number of samples in the reference block that have been predicted or reconstructed, and use the selected samples (referred to as original samples) to determine the second set MPM. In some embodiments, each of the plurality of available intra prediction modes is used to perform intra prediction (or reconstruction) of the original samples, thereby generating predicted samples (or reconstructed samples) of the original samples. Based on the predicted samples (or reconstructed samples) and the original samples, the second set MPM is selected from the plurality of available intra prediction modes. When an intra prediction mode in the second set MPM is selected for intra prediction of the luma block, shorter bits may be used to code the selected intra prediction mode, thus reducing signaling overhead, and improving coding efficiency.

Video data may include a sequence of still images or frames, and each frame may include picture elements or pixels. Pixels of each frame may be grouped as macroblocks for processing. Each pixel may be assigned an integer value, e.g., 0, 1, 2, . . . , or 256, that represents an image quality or characteristic, such as luminance or chrominance. Video data may be compressed before being communicated for reducing the amount of data in communication. Modern methods of video compression exploit spatial correlations using various techniques, which may be known as intra-frame prediction (or intra prediction). Intra prediction may reduce spatial redundancies between adjacent and/or neighboring macroblocks in the same frame, thereby compressing video data without greatly reducing image quality. Different forms of intra prediction have been described by various video/image coding standards, such as International Telecommunications Union (ITU) Telecommunications Standardization Sector (ITU-T) H.264, International Organizational Electrotechnical Commission (IEC) Moving Picture Expert Group (MPEG) 4 Visual, and High Efficiency Video Coding (HEVC). Intra prediction may be implemented by video coders/decoders (or Codecs), which interpolate a predicted macroblock from one or more previously coded/decoded neighboring blocks, and create an approximation of a current macroblock.

HEVC is a video coding standard developed by the Joint Collaborative Team on Video Coding (JCT-VC). HEVC may utilize 35 intra prediction modes for prediction of a luma block. To ensure a selected mode for the luma block is signaled with minimal overhead, HEVC defines a set of three most probable modes (MPMs) for each luma prediction block based on prediction modes of two neighbors of a corresponding luma prediction block. For example, to perform intra prediction of a current luma block of a video frame/picture, a set of MPMs may first be determined for the luma block based on prediction modes of two neighbors of the luma block. The set of MPMs includes 3 intra prediction modes selected from the 35 intra prediction modes. An intra prediction mode to be used for the current luma block may be then selected from the set of MPMs. If none of the set of MPMs is selected, the intra prediction mode to be used for the current luma block may be selected from the rest of the 35 intra prediction modes (i.e., the remaining 32 intra prediction modes). Thus, if the intra prediction mode selected for the current luma block is not one of the three MPMs, the luma block is coded as one of the remaining modes. A current block in this disclosure may be referred to a block that is to be processed, e.g., by performing intra prediction for encoding or performing reconstruction for decoding.

The intra prediction modes of HEVC may utilize the same set of reference samples adjacent to the current luma block. In an example where the current luma block has a size of N×N (i.e., the luma block includes N×N pixels), to predict this luma block, a total of 4N+1 spatially neighboring reference samples of the luma block may be used. These reference samples may be derived using a reference substitution process. Some neighboring reference samples may be unavailable for intra prediction. For example, some reference samples are outside of the picture. In this case, HEVC allows the nearest available neighboring samples to be used as a substitute for the unavailable ones. Once all reference samples are derived, the intra prediction mode for the current luma block is selected from one of the 35 intra prediction modes.

By use of a set of three most probable modes (referred to herein as the first set MPM), an intra prediction mode may be signaled with a generally reduced or minimized overhead. The first set MPM for a luma block may be derived based on predictions modes of its two neighboring blocks, e.g., one above (referred to as the above neighbor block) and one to the left (referred to as the left neighbor block) of the luma block. This may be based on the assumption that the current luma block may most probably be encoded in the same mode as its neighbors. In the example above for predicting the current N×N luma block, when obtaining the first set MPM, the intra prediction mode to be selected for the current luma block may be one of the first set MPM, or one of the remaining modes, e.g., the remaining 32 intra prediction modes in the 35 intra prediction modes. When the first set MPM are determined based on the left neighbor block and the above neighbor block of the current luma block, information about the first set MPM may be available both at an encoder performing the intra prediction and an decoder to decode the luma block. Thus, in a first case when the intra prediction mode for the current luma block is selected from the first set MPM, an index of an intra prediction mode in the first set MPM may be transmitted to the decoder using one to two bits. This greatly reduces the overhead for indicating the selection of an intra prediction mode. Otherwise, in a second case when the intra prediction mode for the current luma block is selected from the remaining 32 intra prediction modes, a 5-bit fixed length code (5 bits are used to indicate 32 intra prediction modes) may be used for coding the selected intra prediction mode. The coding efficiency of the first case is higher than that of the second one.

In some embodiments, an indication may be used to indicate whether or not one intra prediction mode of the first set MPM is used to predict the current luma block. For example, current HEVC uses a flag prev_intra_luma_pred_flag to indicate this. When this flag is 1, which indicates that the first set MPM is used for predicting the current luma block, an index of an MPM in the first set MPM, i.e., an mpm_idx, is coded to indicate which MPM in the first set MPM is selected to predict the current luma block. Otherwise, a remaining mode rem_intra_luma_pred_mode is coded (i.e., one of the remaining intra prediction mode is selected to predict the current luma block), as shown by a pseudo-code below in Table 1.

TABLE 1

If prev_intra_luma_pred_flag

mpm_idx

Else

rem_intra_luma_pred_mode

As discussed above, when an intra prediction mode to be used for performing intra prediction of a current luma block is selected from the remaining intra prediction modes, instead of the first set MPM, more bits (e.g., 5 bits are used to indicate 32 intra prediction modes) may be needed to indicate the selected intra prediction mode, causing higher transmission overhead, and reduced coding efficiency. In some embodiments, a second set MPM for the current luma block may be determined and used for coding the current luma block. The second set MPM may include a set of intra prediction modes that are different from the first set MPM. When the first set MPM is not used, the second set MPM, instead of the remaining 32 intra prediction modes, are used to select an intra prediction mode for the current luma block. An intra prediction mode that is selected from the second set MPM may be indicated using less bits, depending on the number of intra prediction modes included in the second set MPM. This can further improve coding efficiency of intra prediction modes.

The second set MPM may be determined and used on the encoder side and/or the decoder side. On the encoder side, the second set MPM may be generated for a luma block for performing intra prediction on the luma block. In some embodiments, the second set MPM may be generated using reference samples of the luma block that have been predicted using intra prediction modes. On the decoder side, the second set MPM may be generated for a luma block for reconstructing the luma block. In some embodiments, the second set MPM may be generated using reference samples of the luma block that have been reconstructed according intra prediction modes.

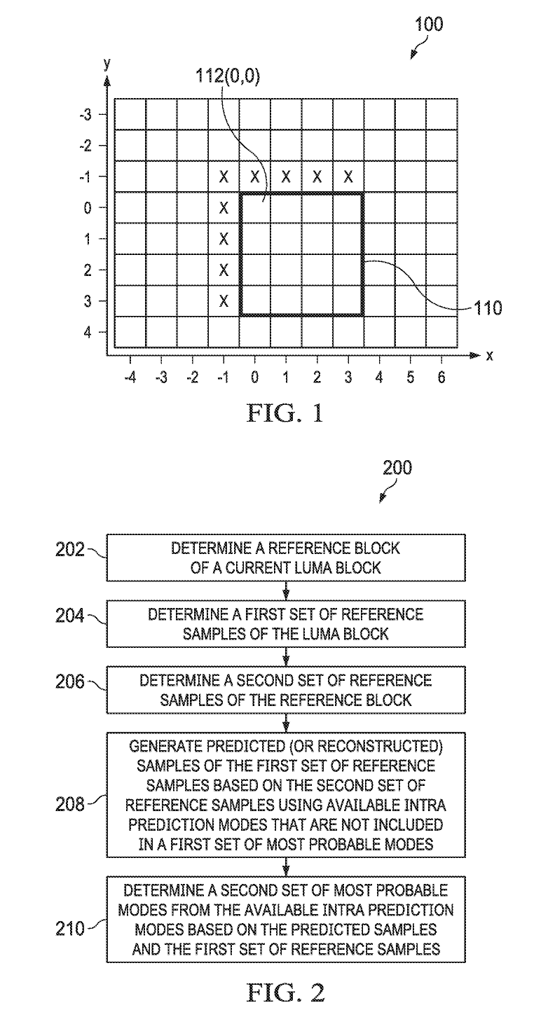

FIG. 1 illustrates an embodiment video frame 100 including a plurality of pixels. FIG. 1 illustrates the plurality of pixels using small squares formed by a grid. Each small square represents a pixel. A pixel may be defined by a location (x,y) on a frame and a value assigned to the pixel representing a picture characteristic. A pixel may also be referred to as a pixel sample (or sample). The terms of “pixel” and “sample” may be used interchangeably throughout the disclosure. A pixel sample may be represented by P(x,y). In one embodiment, position of the top-left sample of a current luma block of size N×N that is to be predicted and coded using an intra prediction mode (the current luma block may also be referred to as the current luma prediction block) may be set as the origin (0, 0), and other samples may be represented relatively to the origin. N represents a number of pixels in each row or column of a block. Reference samples of a current luma prediction block may be represented with x<0, or y<0, or both x<0 and y<0. For example, 4N+1 reference samples of a current luma prediction blocks of size N×N may include samples P(x, y) located at x=−1, and y=−1, 0, 1, 2, . . . N*2−1, respectively, and also samples P(x, y) located at x=0, 1, 2, . . . N*2−1, and y=−1, respectively. FIG. 1 illustrates an example of a current luma prediction block 110 of size 4×4. That is, N=4. With the top top-left sample 112 of the luma prediction block 110 taken as the origin (0,0), reference samples (e.g., the squares marked by “X” in FIG. 1) of the luma prediction block 110 may include P(−1,3), P(−1,2), P(−1,1), P(−1,0), P(−1,−1), P(0,−1), P(1,−1), P(2,−1), and P(3,−1). The embodiments in the following will be described using the similar representation of pixel samples. Those of ordinary skill in the art would recognize many variations and alternatives to represent pixel samples of frames for intra prediction.

FIG. 2 illustrates a flowchart of an embodiment method 200 for deriving a second set MPM for a current N×N luma block using reference samples of the luma block. In general, the method may construct a reference block of the current luma block, select a set of samples in the reference block, and use the set of samples to check each of intra prediction modes that are available for derive the second set MPM. In some embodiments, the method may check the intra prediction modes and select as the second set MPM those that may result in criterion-satisfying performance for predicting the set of selected samples. For example, those intra prediction modes with the best prediction performance may be selected. In another example, intra prediction modes that result in prediction performance exceeding a threshold may be selected. Other applicable criteria may also be used in selecting the intra prediction modes for the second set MPM. The number of intra prediction modes in the second set MPM may be predetermined, and a predetermined number of modes that satisfy a criterion may be selected as the second set MPM.

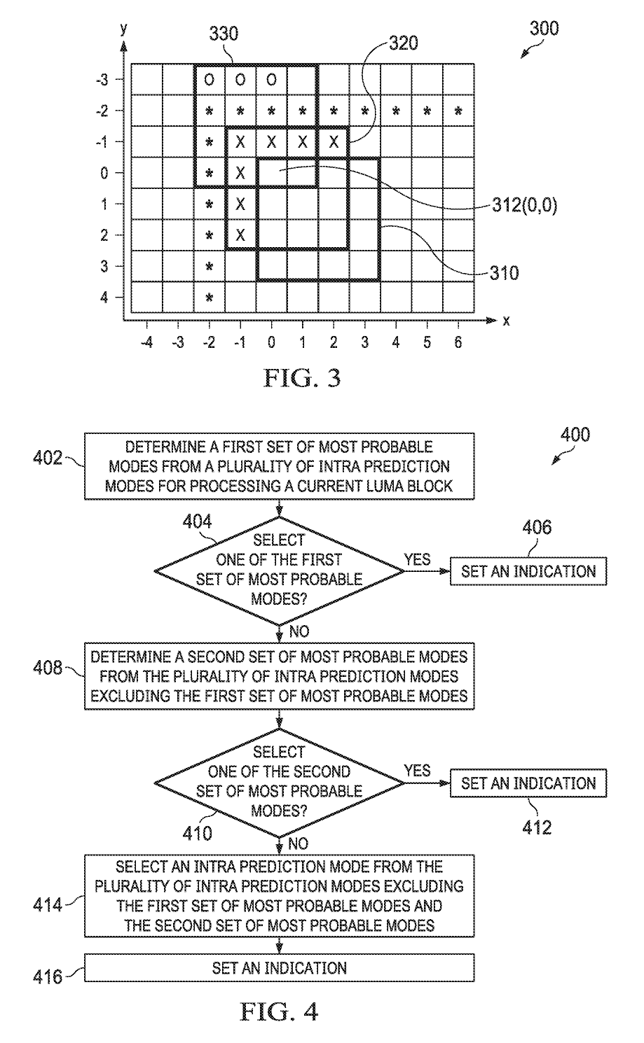

In the following, the method 200 will be described in reference to FIG. 2 and FIG. 3. At step 202, the method 200 determines a reference block of the luma block. The reference block in this example is constructed in order to determine a set of reference samples to be used for generating the second set MPM. The reference block may have a size that is the same as or different from the luma block. In some embodiments, the reference block may be a block of size N×N with its top-left sample located at (−L1, −L2) relative to the top-left sample 312 of the current luma block which is the origin (0,0). In this case, the reference block is generally located to the left of and/or above the luma block. L1 and L2 are integers. L1 and L2 may be referred to as displacement from the top-left sample of the current block. L1 may indicate a distance (in terms of a number of pixels) between the top-left sample of the reference block and the top-left sample of the current luma block in the horizontal direction (x axis). L2 may indicate a distance (in terms of a number of pixels) between the top-left sample of the reference block and the top-left sample of the luma block in the vertical direction (y axis). FIG. 3 illustrates another embodiment video frame 300, which is the same as the video frame 100 in FIG. 1. FIG. 3 illustrates a 4×4 luma block 310 as the current luma block to be processed. A top-left sample 312 of the luma block 310 is set as the origin (0,0). A 4×4 reference block 320 is generated for the luma block 310 with displacement (−1,−1). In this example, the top-left sample of the reference block 320 has a location of (−1,−1), and the reference block 320 has the same size as the luma block 310. As shown, the reference block 320 includes pixels (marked by “X”) that are not in the luma block 310, and also pixels that are in the luma block 310.

L1 and L2 may take any value such as 1, 2, 3, 4, etc. L1 may be equal to or different than L2. In one embodiment, a fixed value of displacement L1=L2=1 may be used for one or more different processing unit (PU) sizes. In another embodiment, L1 and/or L2 may be determined based on a PU size. For example, L 1=L2=1 when PU size <16, and L1=L2=2 for larger PU sizes. In another example, for a smaller PU size, L1 and/or L2 may be set as 1, while for a larger PU size, L may be increased. In some embodiments, one or more different reference blocks may be generated for the luma block 310. For example, multiple reference blocks with top-left samples having different locations, such as (−1, 0), (0, −1), (−2,−2), may be created. FIG. 3 also illustrates a second reference block 330 constructed for the luma block 310, which has displacement (−2,−3). In the cases where multiple blocks are created/generated, more reference samples may be selected relative to the current luma block. The number of reference blocks to be used and positions of the reference blocks may be predetermined, and be a priori knowledge to both an encoder and a decoder.

Referring back to FIG. 2, at step 204, the method 200 determines a first set of reference samples of the luma block that are located within the generated reference block, but not in the luma block. The first set of reference samples are samples that have been predicted or reconstructed. The first set of reference samples may be referred to as original samples of the reference block throughout the disclosure, and represented as origSamples (x,y). For example, the original samples may be located where x=−1, y=−1, . . . , N−2, and x=0, . . . , N−2, y=−1, respectively. The first set of reference samples may not include any samples located in the luma block. In some embodiments, the method 200 determines locations of the first set of reference samples, and assigns corresponding values to the reference samples. The first set of reference samples may be derived using the substitution process in HEVC. In one embodiment, unfiltered reference samples located at x=−1, y=−1, . . . , N−2 and x=0, . . . , N−2, y=−1, may be used as original samples origSamples(x, y). In another embodiment, these samples may be filtered using a filtering process of HEVC, or any other filtering methods. The first set of reference samples may then be replaced by the filtered samples. Taking the video frame 300 in FIG. 3 as an example, the first set of reference samples may be determined to be those marked by “X” in the reference block 320. These reference samples may be represented by origSamples (−1,2), origSamples (−1,1), origSamples (−1,0), origSamples (−1,−1), origSamples (0,−1), origSamples (1,−1), and origSamples (2,−1). These reference samples may be filtered or unfiltered samples. In some embodiments, the first set of reference samples may include all or less than all samples in the reference block 320 that are not in the luma block 310. The first set of reference samples correspond to the reference block and may be associated with the reference block.

In some embodiments, when more than one reference blocks are generated, one set of such original samples within at least one of the reference blocks may be determined for the luma block. For example, within each of the generated reference blocks, one set of reference samples of the luma block is derived and filled with corresponding values. In the example of FIG. 3, a set of original samples within the reference block 330 is also derived, which are marked by “0” in the reference block 330. These reference samples may be represented by origSamples(−2,−3), origSamples(−1,−3) and origSamples(0, −3).

At step 206, the method 200 determines a second set of reference samples of the reference block. The second set of reference samples may be neighboring reference samples of the reference block. The neighboring reference samples are adjacent to the reference block. The neighboring reference samples may have been predicted or reconstructed. In one embodiment, the 4N+1 neighboring reference samples of the reference block may be derived and used, which are located at x=−2, y=−2, −1, . . . N*2−2, and x=−1, 0, . . . , N*2−2, y=−2. The second set of reference samples may be derived using the substitution process in HEVC. The second set of reference samples may be unfiltered, or filtered, e.g., using a filtering process of HEVC or any other applicable filtering method. In some embodiments, a subset of the 4N+1 neighboring reference samples of the reference block may be derived and used. For example, only neighboring reference samples from above of and to the left of the reference block may be derived. In the example of FIG. 3, the 4N+1 neighboring reference samples (marked by *) of the reference block 320 are derived, which are located at x=−2, y=−2, −1, . . . , 4, and x=−1, 0, . . . , 6, y=−2. The method may also only use the neighboring reference samples located at x=−2, y=−2, . . . , 2, and x=−1, 0, . . . , 2, y=−2.

At step 208, the method 200 generates predicted (or reconstructed) samples of the first set of reference samples based on the second set of reference samples using available intra prediction modes that are not included in the first set MPM. In some embodiments, the method 200 uses each of available intra prediction modes (excluding the intra prediction modes in the first set MPM) to perform intra prediction on the first set of reference samples based on the second set of reference samples, thereby generating a set of predicted samples of the first set of reference samples. In an example where 35 intra prediction modes in total are used and the first set MPM includes three of the 35 intra prediction modes, the method 200 may use each of the remaining 32 available intra prediction modes to perform prediction of the first set of reference samples, thereby generating 32 sets of predicted samples. The predicted samples may be derived by using the 4N+1 reference samples obtained above for each of intra prediction modes that are not included in the first set MPM, following the intra prediction process in HEVC. The predicted samples may be represented by predSamples(x, y), where x=−1, y=−1, . . . , N−2 and x=0, . . . , N−2, y=−1. In some embodiments, the method 200 may use a subset of all available intra prediction modes to generate the predicted samples. For example, the 35 intra prediction modes are numbered from 1 to 35, and only even numbered intra prediction modes may be checked in a first round and then some of the even numbered intra prediction modes may be selected. In a second round, odd numbered neighbor intra prediction modes of the selected even numbered intra prediction modes are checked, from which one or more intra prediction may further be selected.

At step 210, the method 200 determines the second set MPM from the available intra prediction modes (excluding the intra prediction modes in the first set MPM) based on the predicted samples predSamples(x, y) and the original samples origSamples(x, y) (i.e., the first set of reference samples), where x=−1, y=−1, . . . , N−2 and x=0, . . . , N−2, y=−1. In some embodiments, distortions between the origSamples(x, y) and the predSamples(x, y) may be measured/calculated and used to select intra prediction modes for the second set MPM. The distortions may also be referred to as prediction errors. For example, a number of intra prediction modes that result in the smallest distortions may be selected as the second set MPM. In some embodiments, the distortions may be measured using sum of absolute difference (SAD), denoted as sad(ModeIntra), where ModeIntra denotes an available intra prediction mode that may be used to generate the second set MPM. For example, an absolute difference between each of the samples in the origSamples(x, y) and the predSamples(x, y) is calculated for a intra prediction mode, and the absolute differences corresponding to the samples are added up to obtain a SAD value for the intra prediction mode. Thus, a set of SAD values may be obtained corresponding to a number of available intra prediction modes. For example, 32 SAD values may be calculated corresponding to the 32 remaining intra prediction modes. In some embodiments, the obtained SAD values may be sorted in an increasing order together with their corresponding intra prediction modes. The first M intra prediction modes with the smallest SAD values may be selected as the second set MPM, in the sorted order. In some embodiments, M intra prediction modes having SAD values less than a threshold may be selected. The number of selected intra prediction modes M may be 3, 4, 5, or any other number. The number M may be determined in consideration of transmission overhead that may be allowed. Those of ordinary skill in the art would recognize that many other ways to measure distortions, e.g., sum of squared difference (SSD), may also be used to determine the second set MPM. When multiple reference blocks are generated, 32 SAD values corresponding to 32 intra prediction modes may be generated for each of the reference block. For example, when two reference blocks are generated, 64 (i.e., 32×2=64) SAD values are calculated, and each of the SAD value corresponds to one of the 32 intra prediction modes. The second set MPM may then be selected based on the 64 SAD values. For example, the 64 SAD values may then be sorted with their corresponding intra prediction modes, and the first M intra prediction modes having threshold-satisfying SAD values may be selected as the second set MPM.

FIG. 4 illustrates a flowchart of an embodiment method 400 for determining an intra prediction mode for a current luma block. The method 400 may be performed by an encoder. At step 402, the method 400 determines a first set MPM from a plurality of intra prediction modes for processing a current luma block. The first set MPM include three intra prediction modes selected from the plurality of intra prediction modes. At step 404, the method 400 determines whether one of the first set MPM is selected for the current luma block. An intra prediction mode may be selected from the first set MPM based on a predetermined criterion or rule. When one of the first set MPM is selected, the method 400 proceeds to step 406 to set an indication to indicate the selection. For example, a flag prev_intra_luma_pred_flag is set to be 1 to indicate that one of the first set MPM is selected for the current luma block. The selected one will be used to predict the current luma block. An encoder may send to a decoder information indicating that the first set MPM is used, and also information indicating the selected one of the first set MPM, such as an index, e.g., mpm_idx, of the selected intra prediction mode, and the decoder may use the selected one to perform block reconstruction.

When none of the first set MPM is selected, the method 400 proceeds to step 408. At step 408, the method 400 determines a second set MPM from the plurality of intra prediction modes excluding the first set MPM. The second set MPM may include multiple intra prediction modes selected from the plurality of intra prediction modes, but not include any intra prediction mode in the first set MPM. The second set MPM may be determined using the method as illustrated in FIG. 2. At step 410, the method 400 determines whether one of the second set MPM is selected for the current luma block. An intra prediction mode may be selected from the second set MPM based on a predetermined criterion or rule. When one of the second set MPM is selected, the method 400 proceeds to step 412 to set an indication to indicate the selection. For example, a flag sec_intra_luma_pred_flag may be set, e.g., 1, to indicate that one of the second set MPM is selected for the current luma block. The selected one will be used to predict the current luma block. The encoder may send to a decoder information indicating that the second set MPM is used, and also information indicating the selected one of the second set MPM to a decoder, such as an index, e.g., mpm_idx2, of the selected intra prediction mode, and the decoder may use the selected one to perform block reconstruction. When none of the second set MPM is selected, the method 400 proceeds to step 414, where an intra prediction mode is selected for the current luma block from the plurality of intra prediction modes excluding the first set MPM and the second set MPM. The intra prediction mode may be selected based on a predetermined criterion or rule. At step 416, the method 400 sets an indication indicating the selected intra prediction mode. The method 400 may select an intra prediction mode from the first set MPM, the second set MPM, or the remaining intra prediction modes using the same or different criteria or rules.

Table 2 shows a pseudo code for intra prediction mode coding. When a current luma prediction block uses an intra prediction mode not belonging to any of the first set MPM, the flag prev_intra_luma_pred_flag is coded as zero. Another flag sec_intra_luma_pred_flag is used to indicate whether the current luma block uses an intra prediction mode from the second set MPM. If the flag sec_intra_luma_pred_flag equals one, an additional syntax element mpm_idx2 is coded. Otherwise, a remaining intra prediction mode rem_intra_luma_pred_mode is coded. The mpm_idx2 may be binarized using truncated unary code and each bin may be coded with a context model in entropy coding. The mpm_idx2 may also be coded using other schemes, for example, fixed length coding. The sec_intra_luma_pred_flag may be coded using a context model, or other applicable mode, such as a bypass mode. In some embodiments, specific values of the flags may be reversed. In some embodiments, flags sec_intra_luma_pred_flag of neighboring blocks of the current luma block may be checked, and when the flag of the current luma block is same as that of its neighboring block, the flag of the current luma block need not be coded for the current luma block.

TABLE 2

If prev_intra_luma_pred_flag

mpm_idx

else

if sec_intra_luma_pred_flag

mpm_idx2

else

rem_intra_luma_pred_mode

The embodiment method for deriving the second set MPM may be applied for both an encoder and a decoder. In some embodiments, when the second set MPM is used for predicting a luma block, indication of the selected intra prediction mode in the second set MPM may not need to be sent to a decoder. Instead, the decoder may use the method as illustrated in FIG. 2 to derive the second set MPM, and select one of the intra prediction modes in the second set MPM based on a criterion the same as that used by the encoder. The encoder may only indicate to the decoder that the second set MPM is used. In this case, the first set of reference samples of a current luma block and the second set of reference samples of a reference block constructed for the current luma block may be samples that have been reconstructed based on one or more intra prediction modes. An embodiment may generate reconstructed samples of the first set of reference samples according to each of the intra prediction modes using the second set of reference samples, and calculate reconstruction errors (or distortions) by comparing the first set of reference samples and the reconstructed samples, e.g., using SAD or SSD. Based on the calculated reconstruction errors, the second set MPM may be determined, e.g., using similar methods as illustrated in FIG. 2. The decoder may then reconstruct the current luma block using an intra prediction mode in the second set MPM.

The second set MPM may be determined dynamically. The intra prediction modes included in the second set MPM may not be fixed, and may be updated during intra prediction. Hence, the second set MPM provides additional MPM beyond the first set MPM, i.e., the MPM modes defined in HEVC, so as to adapt to the current block texture in intra prediction. Generating the second set MPM for intra prediction helps reduce the long coding bits that may be required when the first set MPM is not used, and as a result, achieves bit saving.

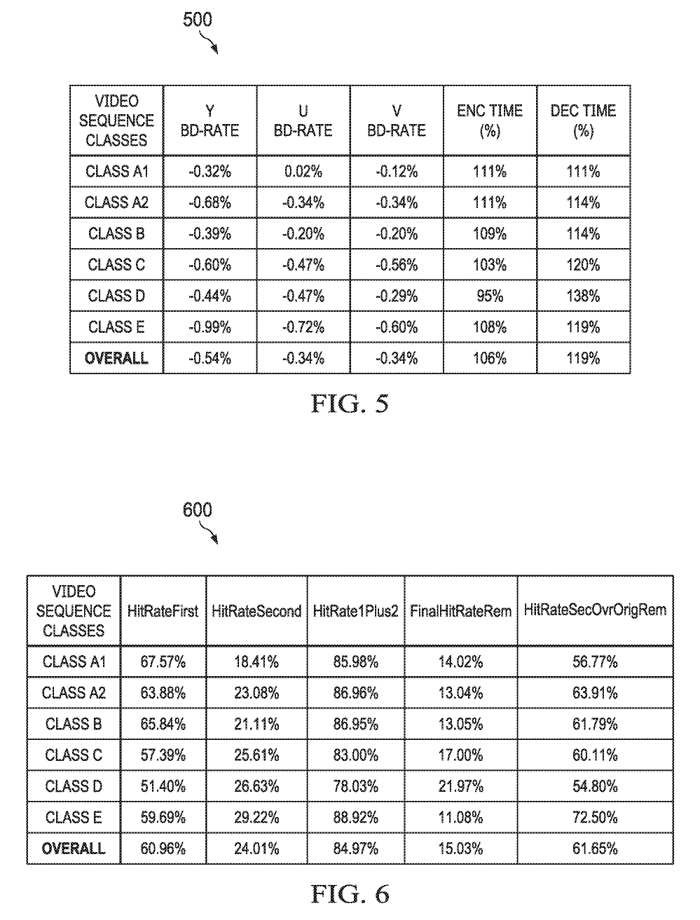

FIG. 5 is a table 500 showing BD-rate performance obtained using the embodiment method for intra prediction compared with that obtained using HM-16.6 (AI Main 10). In this example, the number of modes in the second set is set to be 4, which is determined based on extensive testing results. However, as discussed above, different values, such as 3, 5, and the like, may be used. FIG. 5 shows that, compared with HM-16.6, BD-rates obtained by using the embodiment method are generally reduced for all video classes except Class A1 for U. The reduction of BD-rates is shown to be up to −0.99%, with an average of −0.54%, −0.34%, and −0.34% for Y, U, and V, respectively.

The performance of using the embodiment method for intra prediction may also be evaluated in a different point of view. It has been shown that when an intra prediction mode of a current block belongs to the first set MPM, coding the index of this intra prediction mode in the first set MPM may need fewer bits than coding the remaining intra prediction mode. There may be cases where more PUs are hit by the first set MPM and or the second set MPM, i.e., more Pus use the first set MPM and or the second set MPM.

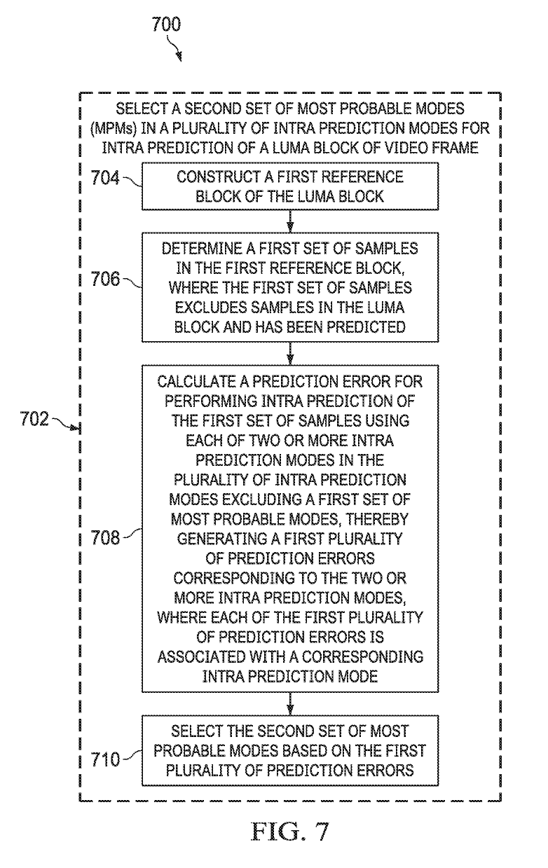

FIG. 6 is another table 600 showing BD-rate performance obtained using the embodiment method for intra prediction compared with that obtained using HM-16.6. In this example, a PU that is hit by the first set MPM or the second set MPM may be referred to as a PU for which the first set MPM or the second set MPM is selected for intra prediction or reconstruction. The following parameters are defined and used in the example.

totalPU: total number of PUs,

totalPUHitFirst: total number of PUs hit by the first set MPM,

totalPUHitSecond: total number of PUs hit by the second set MPM,

totalPUHitFirstAndSecond: total number of PUs hit by both sets altogether,

origTotalPURemaining: total number PUs not hit by the first set MPM, and

finalTotalPURemaining:total number PUs coded using remaining modes.

Relations among the parameter are as follows:

totalPU=totalPUHitFirst+totalPUHitSecond+finalTotalPURemaining, and

origTotalPURemaining=totalPU−totalPUHitFirst.

Hit rates are defined as follow:

HitRateFirst=totalPUHitFirst/totalPU,

HitRateSecond=totalPUHitSecond/totalPU,

HitRate1Plus2=totalPUHitFirstAndSecond/totalPU,

FinalHitRateRem=finalTotalPURemaining/totalPU, and

HitRateSecOvrOrigRem=totalPUHitSecond/origTotalPURemaining.

BD-rate performance in terms of the hit rates defined above is shown in FIG. 6. As shown, the HitRateSecOvrOrigRem overall can reach 61.65%. This indicates that, using the embodiment method, PUs, that may have to be coded using remaining modes when the second set MPM is not available, can be coded using indexes of the second MPM set. On average, HitRateFirst, HitRateSecond, HitRate1Plus2, and FinalHitRateRem are 60.96%, 24.01%, 84.97% and 15.03%, respectively. A primary contributor of coding efficiency may be the first set MPM, and then further improvement may come from the second set MPM. Both sets altogether may hit 84.97% PUs and leave only 15.03% PUs coded using remaining modes.

FIG. 7 illustrates a flowchart of an embodiment method 700 for intra prediction. The method 700 may be indicative of operations at a video processing device, such as an encoder, or a codec. As shown, at step 702, the method 700 selects a second set of most probable modes (MPMs) in a plurality of intra prediction modes for intra prediction of a luma block of a video frame. The second set of MPMs includes a predetermined number of intra prediction modes in the plurality of intra prediction modes excluding a first set of MPMs in the plurality of intra prediction modes. The second set of MPMs may be derived using steps 704-710. At step 704, the method 700 constructs a first reference block of the luma block. Each of the first reference block and the luma block includes a plurality of samples. At step 706, the method 700 determines a first set of samples in the first reference block, where the first set of samples excludes samples in the luma block and has been predicted. At step 708, the method 700 calculates a prediction error for performing intra prediction of the first set of samples using each of two or more intra prediction modes in the plurality of intra prediction modes excluding the first set of MPMs, thereby generating a first plurality of prediction errors corresponding to the two or more intra prediction modes, where each of the first plurality of prediction errors is associated with a corresponding intra prediction mode. At stem 710, the method 700 selects the second set of MPMs based on the first plurality of prediction errors.

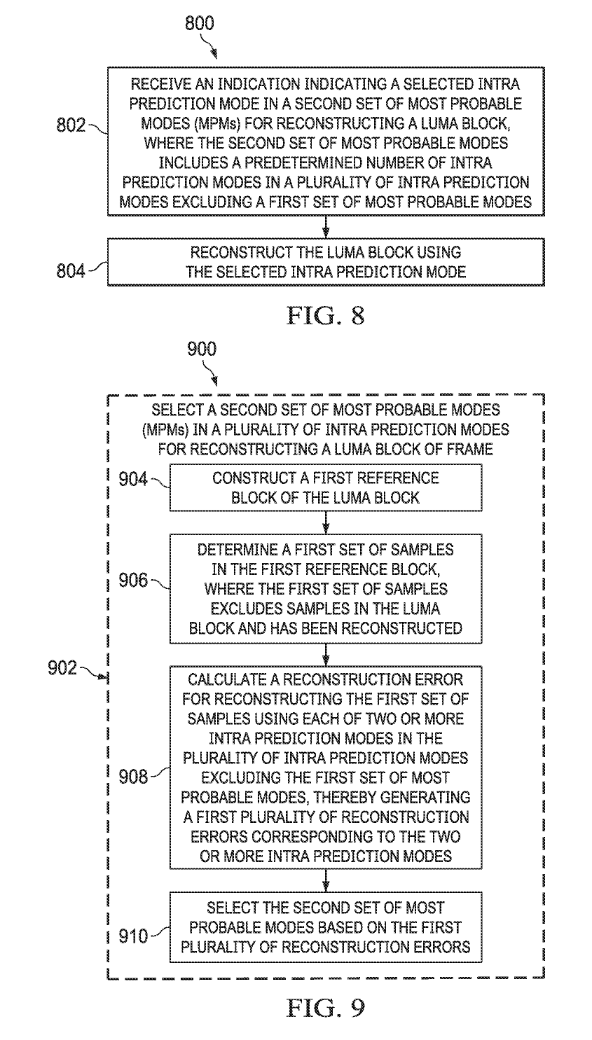

FIG. 8 illustrates a flowchart of an embodiment method 800 for decoding a luma block of a video frame. The method 800 may be indicative of operations at a video processing device, such as a decoder, or a codec. At step 802, the method 800 receives an indication indicating a selected intra prediction mode in a second set of most probable modes (MPMs) for reconstructing a luma block. The second set of MPMs includes a predetermined number of intra prediction modes in a plurality of intra prediction modes excluding a first set of MPMs in the plurality of intra prediction modes. At step 804, the method 800 reconstructs the luma block using the selected intra prediction mode.

FIG. 9 illustrates a flowchart of an embodiment method 900 for decoding a luma block of a video frame. The method 900 may be indicative of operations at a video processing device, such as an encoder, or a codec. At step 902, the method goo selects a second set of most probable modes (MPMs) in a plurality of intra prediction modes for reconstructing a luma block of a frame. The second set of MPMs includes a predetermined number of intra prediction modes in the plurality of intra prediction modes excluding a first set of MPMs in the plurality of intra prediction modes. The second set of MPMs may be derived using steps 904-910. At step 904, the method 900 constructs a first reference block of the luma block. Each of the first reference block and the luma block includes a plurality of samples. At step 906, the method 900 determines a first set of samples in the first reference block. The first set of samples excludes samples in the luma block and has been reconstructed. At step 908, the method 900 calculates a reconstruction error for reconstructing the first set of samples using each of two or more intra prediction modes in the plurality of intra prediction modes excluding the first set of MPMs, thereby generating a first plurality of reconstruction errors corresponding to the two or more intra prediction modes. Each of the first plurality of reconstruction errors is associated with a corresponding intra prediction mode. At step 910, the method 900 selects the second set of MPMs based on the first plurality of reconstruction errors.

In some embodiments, a video processing device may be provided to perform the embodiment methods. The video processing device may include a non-transitory memory storage comprising instructions, and one or more processors in communication with the memory storage. In one embodiment, the one or more processors may execute the instructions to: receive indication indicating a selected intra prediction mode in a second set of most probable modes (MPMs) for reconstructing a luma block, where the second set of MPMs includes a predetermined number of intra prediction modes in a plurality of intra prediction modes excluding a first set of MPMs in the plurality of intra prediction modes; and reconstruct the luma block using the selected intra prediction mode.

In another embodiment, the one or more processors may execute the instructions to: select a second set of most probable modes (MPMs) in a plurality of intra prediction modes for reconstructing a luma block of a frame, where the second set of MPMs includes a predetermined number of intra prediction modes in the plurality of intra prediction modes excluding a first set of MPMs in the plurality of intra prediction modes. The second set of MPMs may be derived by: constructing a first reference block of the luma block, where each of the first reference block and the luma block may include a plurality of samples; determining a first set of samples in the first reference block, where the first set of samples exclude samples in the luma block and having been reconstructed; calculating a reconstruction error for reconstructing the first set of samples using each of two or more intra prediction modes in the plurality of intra prediction modes excluding the first set of MPMs, thereby generating a first plurality of reconstruction errors corresponding to the two or more intra prediction modes, where each of the first plurality of reconstruction errors is associated with a corresponding intra prediction mode; and selecting the second set of MPMs based on the first plurality of reconstruction errors.

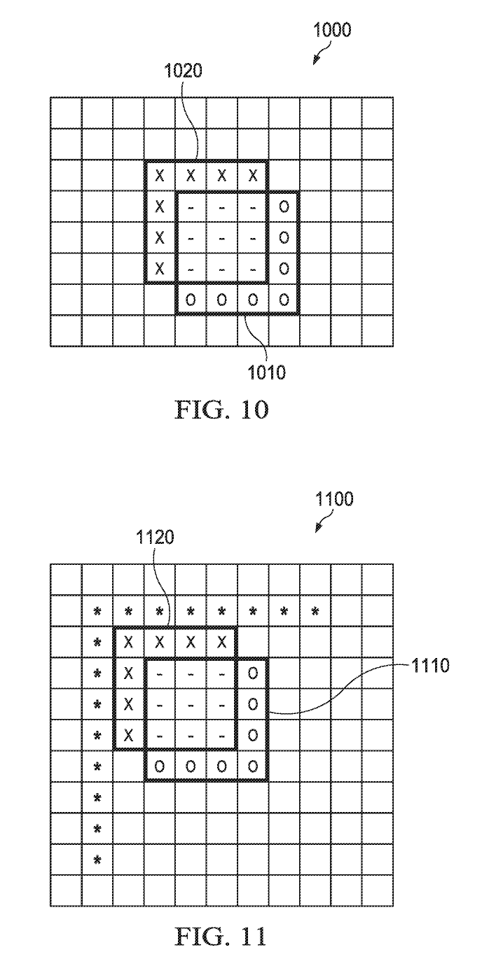

The embodiments improve coding efficiency of intra prediction mode by deriving a second set MPM in addition to the first set MPM using neighboring predicted or reconstructed samples. In some embodiments, steps for deriving the second set MPM for a current luma block may include the following steps. First, a block of size N×N is created/generated with a luma location (−L, −L) specifying the top-left sample of this block relative to the top-left sample of the current luma block. FIG. 10 illustrates a diagram of another embodiment video frame 1000. FIG. 10 uses a 4×4 block as an example, where squares with “00” inside are samples in a current luma block 1010, squares with “X” inside are samples of a created/generated block 1020 that are filled with reference samples relative to the current luma block 1010, and the squares with “−” inside are also samples of the created block 1020 but are not filled.

Second, original samples origSamples(x, y) of the created block (i.e., samples marked by “X” located at x=−1, y=−1, . . . , N−2 and x=0, . . . , N−2, y=−1) are filled by corresponding reference samples. These reference samples may be derived using the substitution process in HEVC.

Third, neighboring reference samples (the 4N+1 reference samples) of this created block located at x=−2, y=−2, . . . , N*2−2 and x=−1, . . . , N*2−2, y=−2 may be derived using the substitution process in HEVC. FIG. 11 illustrates a diagram of another embodiment video frame 1100. Using 4×4 blocks as an example, FIG. 11 illustrates a current luma block 1110, a created block 1120 for the luma block 1110. Similarly, squares with “0” inside are samples in the current luma block 1110, squares with “X” inside are samples of the created block 11200 that are filled with reference samples relative to the current luma block 1110, and the squares with “−” inside are samples of the created block 1120 that are not filled. Squares with “*” inside are the neighboring reference samples of the created block 1120.

In this example, ModeIntra is used to denote each one of the available intra prediction modes for selecting the second set MPM. The total number of the available intra prediction modes may be denoted as NumModes. In the fourth step, Predicted samples predSamples(x, y) of the origSamples(x, y), located at x=−1, y=−1, . . . , N−2 and x=0, . . . , N−2, y=−1, may be derived by using the 4N+1 reference samples derived above for each of ModeIntra=0, . . . , NumModes−1, following the intra prediction process in HEVC. All intra prediction modes in the first MPM set may be excluded. For each ModeIntra, a distortion between the origSamples(x, y) and the predSamples(x, y) may be measured by SAD, and denoted as sad(ModeIntra).

Fifth, all SAD values obtained above may then be sorted in an increasing order together with their corresponding intra prediction modes. The first M intra prediction modes corresponding to the smallest SAD values may be chosen as the second set MPM, in the sorted order.

Sixth, the modified intra prediction mode coding may be enhanced by using the second set MPM as shown in Table 2.

In a first embodiment, in the first step to derive the second set MPM for the current luma block, a block of the same size may be created/generated with a displacement L=1 from the top-left luma location of the current luma block. L may take other values like, 2, 3, 4, 5, etc. The top-left location of this created block may also not be limited to only diagonal positions. For example, (0, −2), (−2, 0), may be possible top-left locations for this created/generated block.

In a second embodiment, in the first step to derive the second set MPM for the current luma block, a fixed value of displacement L=1 may be used for all PU sizes. L may not be limited to have a fixed value for all PU sizes, and it may be determined based on the PU size. For example, L=1 if PU<16 and L=2 for larger PU sizes. That is, for small PU size, L may be selected as 1, while for larger PU size, L may be increased.

In a third embodiment, in the first step to derive the second set MPM for the current block, a single block may be created, or multiple blocks may be created if necessary. For example, multiple blocks may be created with different top-left locations such as (−1, 0), (0, −1). In case multiple blocks are created/generated, more reference samples may be selected relative to the current luma block.

In a fourth embodiment, in the second step to derive the second set MPM for the current luma block, unfiltered reference samples with x=−1, y=−1, . . . , N−2 and x=0, . . . , N−2, y=−1, may be used as original samples origSamples(x, y) of the created block. These samples may also be filtered using a filtering process of HEVC or any other filtering methods. Hence the reference samples may be replaced by filtered samples.

In a fifth embodiment, in the third step to derive the second set MPM for the current luma block, unfiltered reference samples may be used as the neighboring 4N+1 reference samples of the created block. These 4N+1 reference samples may also be filtered using, e.g., the filtering process of HEVC or any other filtering method. In this embodiment, a number of 4N+1 samples are used as the neighboring reference samples of the created block. The number of neighboring reference samples of the created block may be reduced. For example, only samples from above and left neighboring blocks of the created block may be selected,

In a sixth embodiment, in the fourth step to derive the second set MPM for the current luma block, predicted samples may be calculated for every allowed mode of HEVC by excluding modes from the first set MPM. For speeding up, calculation from a subset of intra prediction modes may be utilized if necessary. For example, only even modes may be checked in the first round and a few selected. In the second round, odd neighbors of the selected even modes may be checked.

In a seventh embodiment, in the fifth step to derive the second set MPM for the current luma block, SAD may be used to calculate the distortion between origSamples(x, y) and predSamples(x, y). Other measures of distortion, for example, SSD, may also be used.

In an eighth embodiment, in the fifth step to derive the second set MPM for the current luma block, the first M modes with the smallest SAD values may be chosen as the second set MPM. A typical value of M may be 4. M may take other values, for example, 5 or 6.

In a ninth embodiment, in the sixth step, a flag sec_intra_luma_pred_flag may be coded using a context model. It may also be coded by using a bypass mode if necessary. The flag sec_intra_luma_pred_flag of neighboring blocks may be checked, and if the flag of the current luma block is same as that of a neighboring block, the flag need not be coded for the current luma block.

In a tenth embodiment, in the sixth step, mpm_idx2 may be binarized using truncated unary code and each bin may be coded with a context model in entropy coding. However, mpm_idx2 may be coded using other schemes, for example, fixed length coding.

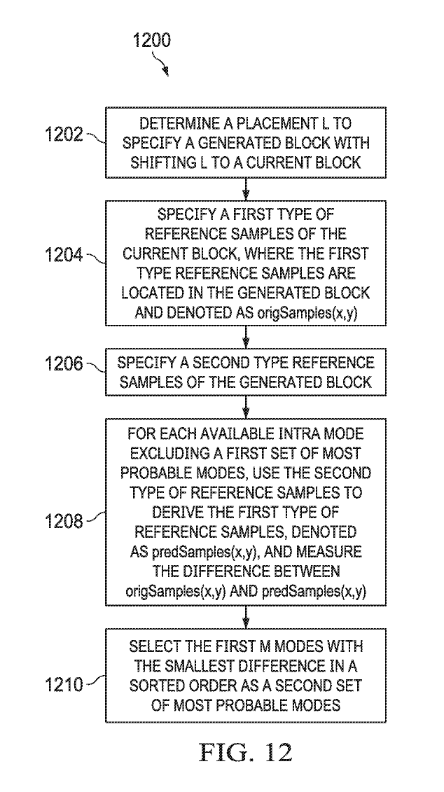

FIG. 12 illustrates a flowchart of an embodiment method 1200 for intra prediction of a current luma block in a video frame. At step 1202, the method 1200 determines a placement L to specify a generated block with shifting L to the current luma block. At step 1204, the method 1200 specifies a first type of reference samples of the current luma block, where the first type reference samples are located in the generated block and denoted as origSamples(x,y). At step 1206, the method 1200 specifies a second type of reference samples of the generated block. At step 1208, for each available intra prediction mode excluding the first set MPM, the method 1200 uses the second type of reference samples to derive the first type of reference samples, generating predicted samples denoted as predSamples(x,y), and measures the difference between origSamples(x,y) and predSamples(x,y). At step 1210, the method 12000 selects the first M modes with the smallest difference in a sorted order as the second set MPM.

An embodiment method for high efficiency video coding includes generating a first set of most probable modes of intra prediction for a luma prediction block, generating a second set of most probable modes of intra prediction for the luma prediction block using neighboring reconstructed samples, wherein the second set of most probable modes does not include any modes in the first set of most probable modes, and signaling, to a decoder, a flag that the current luma prediction block is using a mode of intra prediction in the second set of most probable modes, and an indication of a selected mode of intra prediction in the second set of most probable modes.

An embodiment video processing device includes a non-transitory memory storage comprising instructions and one or more processors in communication with the memory. The one or more processors execute the instructions for generating a first set of most probable modes of intra prediction for a luma prediction block, generating a second set of most probable modes of intra prediction for the luma prediction block using neighboring reconstructed samples, wherein the second set of most probable modes does not include any modes in the first set of most probable modes, and signaling, to a decoder, a flag that the current luma prediction block is using a mode of intra prediction in the second set of most probable modes, and an indication of a selected mode of intra prediction in the second set of most probable modes.

In the embodiment methods, multiple MPM mode sets are used for intra prediction. An MPM mode set in HEVC may be used as the first MPM set (or the first set MPM), where an alternative MPM mode set (or the second set MPM) may be introduced beyond the first MPM mode set may also be used in intra prediction. The intra prediction modes in the alternative MPM mode set are not the same as those in the first MPM set. The alternative MPM mode set may be dynamic, which means that the intra modes in the alternative MPM mode set are not fixed intra modes, and may be updated during the intra prediction.

In HEVC, when prev_intra_luma_pred_flag is 0, an intra prediction mode for a luma prediction block is not in the first set MPM, then the remaining mode, rem_intra_luma_pred_mode, may be coded using 5 bits. In embodiments disclosed herein, instead of directly coding the remaining mode, determination may be made whether the intra prediction mode it is one of the second set MPM modes. If the intra prediction mode is equal to one of them, a sec_intra_luma_pred_flag may be coded as 1 to indicate this; otherwise, the sec_intra_luma_pred_flag may be coded to 0. If sec_intra_luma_pred_flag is coded to 0, the remaining mode, rem_intra_luma_pred_mode, may be coded using 5 bits, as in HEVC. When the sec_intra_luma_pred_flag is 1, the index of the selected mode from the second set MPM, mpm_idx2, may be coded. The mpm_idx2 may be binarized using truncated unary and coded using context models, requiring 1 to 2 bits only.

To improve coding efficiency of the remaining modes, an embodiment derives a second set MPM using neighboring reconstructed samples. To derive the second set MPM, a block with a top-left location(−L, −L) and having the same size as the current luma prediction block may be created with a displacement L=1. L may have different values like 2, 3, 4, etc.

The top-left location of this created block may not be limited to just the diagonal position. For example, the created block may have a top-left at (−2,0) or (0,−2). L May not be limited to have a fixed value for all PU sizes. It may be adaptive based on the PU size. For example, L=1 if PU<16 and L=2 for larger PU sizes.

To derive the second set MPM for a luma prediction block, in one embodiment a single block is created. In other embodiments, multiple blocks may be created. For example, blocks with top-left locations at (−2, 0) and (0, −2) may be created for horizontal and vertical prediction, respectively.

Unfiltered, rather than filtered, reference samples may be used as original samples of the created block, to reduce filtering time. Similarly, unfiltered, rather than filtered, reference samples may be used as the neighboring 4N+1 reference samples for the created block.

Predicted samples may be calculated for every allowed mode of HEVC, excluding modes from the first set MPM to reduce the number of modes for calculations. SAD may be used to calculate distortions between original and predicted samples for the created block to reduce computational complexity. The number of the second set MPM may be set to be 4 in an embodiment of this disclosure. Other values may also be used, for example, 5, 6, etc.

In some embodiments, all modes, excluding the first set MPM, may be checked to derive predicted samples and calculate SAD. In some embodiment, a subset of the allowed modes may be checked for speeding up the process. For example, even modes may be checked in the first round and a few selected. In the second round, odd neighbors of the selected even modes may be checked.

The created block at location (−1, −1) may be filled only with one row and one column, which makes prediction and the SAD calculation faster. The sec_intra_luma_pred flag may be coded using a context model, or a bypass entropy coding. The mpm2_idx may be binarized using truncated unary code and each bin may be coded with a context model. However, mpm2_idx may also be coded using other coding methods, for example, fixed length coding.

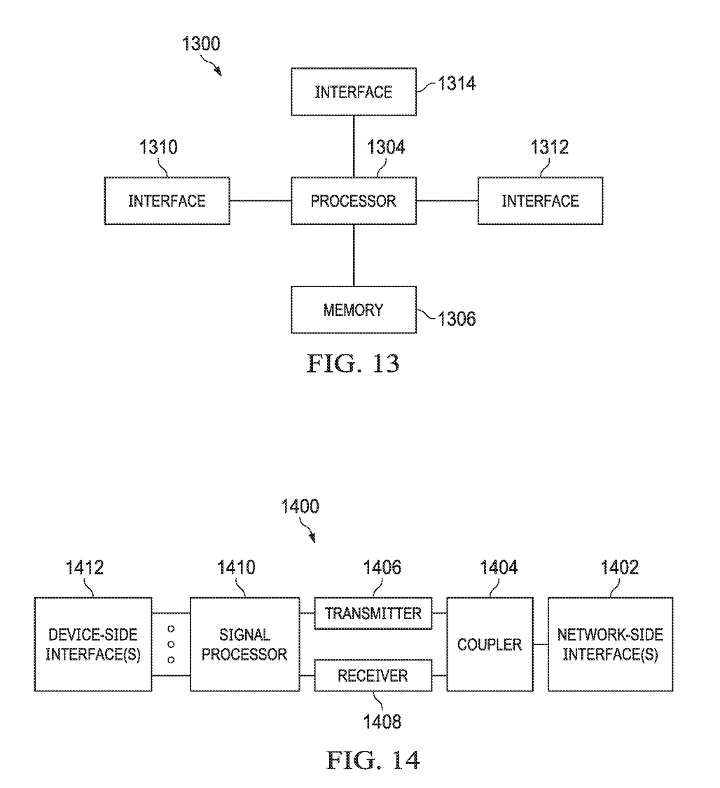

FIG. 13 is a block diagram of a processing system 1300 for performing methods described herein, which may be installed in a host device. As shown, the processing system 1300 includes a processor 1302, a memory 1304, and interfaces 1306-1310, which may (or may not) be arranged as shown in FIG. 13. The processor 1302 may be any component or collection of components adapted to perform computations and/or other processing related tasks, and the memory 1304 may be any component or collection of components adapted to store programming and/or instructions for execution by the processor 1302. In an embodiment, the memory 1304 includes a non-transitory computer readable medium. The interfaces 1306, 1308, 1310 may be any component or collection of components that allow the processing system 1300 to communicate with other devices/components and/or a user. For example, one or more of the interfaces 1306, 1308, 1310 may be adapted to communicate data, control, or management messages from the processor 1302 to applications installed on the host device and/or a remote device. As another example, one or more of the interfaces 1306, 1308, 1310 may be adapted to allow a user or user device (e.g., personal computer (PC), etc.) to interact/communicate with the processing system 1300. The processing system 1300 may include additional components not depicted in FIG. 13, such as long term storage (e.g., non-volatile memory, etc.).

In some embodiments, the processing system 1300 is included in a network device that is accessing, or part otherwise of, a telecommunications network. In one example, the processing system 1300 is in a network-side device in a wireless or wireline telecommunications network, such as a base station, a relay station, a scheduler, a controller, a gateway, a router, an applications server, or any other device in the telecommunications network. In other embodiments, the processing system 1300 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 1306, 1308, 1310 connects the processing system 1300 to a transceiver adapted to transmit and receive signaling over the telecommunications network. FIG. 14 is a block diagram of a transceiver 1400 adapted to transmit and receive signaling over a telecommunications network. The transceiver 1400 may be installed in a host device. As shown, the transceiver 1400 comprises a network-side interface 1402, a coupler 1404, a transmitter 1406, a receiver 1408, a signal processor 1410, and a device-side interface 1412. The network-side interface 1402 may include any component or collection of components adapted to transmit or receive signaling over a wireless or wireline telecommunications network. The coupler 1404 may include any component or collection of components adapted to facilitate bi-directional communication over the network-side interface 1402. The transmitter 1406 may include any component or collection of components (e.g., up-converter, power amplifier, etc.) adapted to convert a baseband signal into a modulated carrier signal suitable for transmission over the network-side interface 1402. The receiver 1408 may include any component or collection of components (e.g., down-converter, low noise amplifier, etc.) adapted to convert a carrier signal received over the network-side interface 1402 into a baseband signal. The signal processor 1410 may include any component or collection of components adapted to convert a baseband signal into a data signal suitable for communication over the device-side interface(s) 1412, or vice-versa. The device-side interface(s) 1412 may include any component or collection of components adapted to communicate data-signals between the signal processor 1410 and components within the host device (e.g., the processing system 1300, local area network (LAN) ports, etc.).

The transceiver 1400 may transmit and receive signaling over any type of communications medium. In some embodiments, the transceiver 1400 transmits and receives signaling over a wireless medium. For example, the transceiver 1400 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1402 comprises one or more antenna/radiating elements. For example, the network-side interface 1402 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1400 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a coding unit/module, a decoding unit/module, a selecting unit/module, a constructing unit/module, a determining unit/module, a calculation unit/module, a generating unit/module, a deriving unit/module, a signaling unit/module, a sorting unit/module, a reconstructing unit/module, and/or a filtering unit/module. The respective units/modules may be hardware, software, or a combination thereof. For instance, one or more of the units/modules may be an integrated circuit, such as field programmable gate arrays (FPGAs) or application-specific integrated circuits (ASICs).

The following reference is related to subject matter of the present application. The reference is hereby incorporated herein by reference in its entirety:
Y. Chen, G. Tech, K. Wegner, S. Yea, “Test Model 9 of 3D-HEVC and MV-HEVC,” JCT3V-11003, 9th Meeting, Sapporo, JP (Jul. 3-9, 2014).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method comprising:
selecting, by an encoder, a second set of most probable modes (MPMs) in a plurality of intra prediction modes for intra prediction of a luma block of a video frame, the second set of MPMs comprising a predetermined number of intra prediction modes in the plurality of intra prediction modes excluding a first set of MPMs in the plurality of intra prediction modes, wherein the second set of MPMs is derived by:
constructing a first reference block of the luma block, each of the first reference block and the luma block comprising a plurality of samples, and the first reference block being different from the luma block;
determining a first set of samples in the first reference block, the first set of samples excluding samples in the luma block and having been predicted;
calculating a prediction error for performing intra prediction of the first set of samples using each of two or more intra prediction modes in the plurality of intra prediction modes excluding the first set of MPMs, thereby generating a first plurality of prediction errors corresponding to the two or more intra prediction modes, each of the first plurality of prediction errors being associated with a corresponding intra prediction mode; and
selecting the second set of MPMs based on the first plurality of prediction errors.

2. The method of claim 1, further comprising:
deriving the first set of MPMs based on a high efficiency video coding (HEVC) standard.

3. The method of claim 1, further comprising:
signaling, by the encoder, a first indication indicating that the second set of MPMs is selected for intra prediction of the luma block; and
signaling, by the encoder, a second indication indicating a selected intra prediction mode in the second set of MPMs.

4. The method of claim 1, wherein the second set of MPMs is selected when the first set of MPMs is not selected for intra prediction of the luma block.

5. The method of claim 1, wherein the second set of MPMs is further derived by:
constructing a second reference block of the luma block that is different from the first reference block;
determining a second set of samples in the second reference block, the second set of samples excluding the samples in the luma block and having been predicted; and
calculating a prediction error for performing intra prediction of the second set of samples using each of two or more intra prediction modes in the plurality of intra prediction modes excluding the first set of MPMs, thereby generating a second plurality of prediction errors corresponding to the two or more intra prediction modes; and
wherein selecting the second set of MPMs comprises selecting the second set of MPMs from the plurality of intra prediction modes excluding the first set of MPMs based on the first plurality of prediction errors and the second plurality of prediction errors.

6. The method of claim 1, wherein calculating the prediction error for performing intra prediction of the first set of samples using each of the two or more intra prediction modes in the plurality of intra prediction modes excluding the first set of MPMs comprises:
determining a set of neighboring reference samples for the first reference block;
generating predicted samples of the first set of samples using the set of neighboring reference samples in accordance with a respective intra prediction mode; and
calculating a respective prediction error corresponding to the respective intra prediction mode based on the first set of samples and the predicted samples.

7. The method of claim 6, wherein calculating the respective prediction error comprises calculating a sum of absolute difference (SAD) of the first set of samples and the predicted samples.

8. The method of claim 6, wherein calculating the respective prediction error comprises calculating a sum of squared difference (SSD) of the first set of samples and the predicted samples.

9. The method of claim 1, wherein selecting the second set of MPMs based on the first plurality of prediction errors comprises:
sorting the first plurality of prediction errors in an ascending order; and
selecting one or more intra prediction modes associated with prediction errors that satisfy a criterion.

10. The method of claim 1, wherein the second set of MPMs comprises four intra prediction modes.

11. The method of claim 1, wherein calculating the prediction error comprises calculating the prediction error for performing intra prediction of the first set of samples using each of the plurality of intra prediction modes excluding the first set of MPMs.

12. A method comprising:
receiving, by a decoder, an indication indicating a selected intra prediction mode in a second set of most probable modes (MPMs) for reconstructing a luma block, the second set of MPMs comprising a predetermined number of intra prediction modes in a plurality of intra prediction modes excluding a first set of MPMs in the plurality of intra prediction modes; and
reconstructing the luma block using the selected intra prediction mode.

13. The method of claim 12, wherein the first set of MPMs is determined based on a high efficiency video coding (HEVC) standard.

14. A method comprising:
selecting, by a decoder, a second set of most probable modes (MPMs) in a plurality of intra prediction modes for reconstructing a luma block of a frame, the second set of MPMs comprising a predetermined number of intra prediction modes in the plurality of intra prediction modes excluding a first set of MPMs in the plurality of intra prediction modes, wherein the second set of MPMs is derived by:
constructing a first reference block of the luma block, each of the first reference block and the luma block comprising a plurality of samples;
determining a first set of samples in the first reference block, the first set of samples excluding samples in the luma block and having been reconstructed;
calculating a reconstruction error for reconstructing the first set of samples using each of two or more intra prediction modes in the plurality of intra prediction modes excluding the first set of MPMs, thereby generating a first plurality of reconstruction errors corresponding to the two or more intra prediction modes, each of the first plurality of reconstruction errors being associated with a corresponding intra prediction mode; and
selecting the second set of MPMs based on the first plurality of reconstruction errors.

15. The method of claim 14, further comprising:
receiving, by the decoder, an indication indicating that the second set of MPMs is selected for intra prediction of the luma block.

16. The method of claim 14, wherein the second set of MPMs is further derived by:
constructing a second reference block of the luma block that is different from the first reference block;
determining a second set of samples in the second reference block, the second set of samples excluding the samples in the luma block and having been reconstructed; and
calculating a reconstruction error for reconstructing the second set of samples using each of two or more intra prediction modes in the plurality of intra prediction modes excluding the first set of MPMs, thereby generating a second plurality of reconstruction errors corresponding to the two or more intra prediction modes; and
wherein selecting the second set of MPMs comprises selecting the second set of MPMs from the plurality of intra prediction modes excluding the first set of MPMs based on the first plurality of reconstruction errors and the second plurality of reconstruction errors.

17. The method of claim 14, wherein calculating the reconstruction error for reconstructing the first set of samples using each of the two or more intra prediction modes in the plurality of intra prediction modes excluding the first set of MPMs comprises:
determining a set of neighboring reference samples for the first reference block;
generating reconstructed samples of the first set of samples using the set of neighboring reference samples in accordance with a respective intra prediction mode; and
calculating a respective reconstruction error corresponding to the respective intra prediction mode based on the first set of samples and the reconstructed samples.

18. The method of claim 17, wherein calculating the respective reconstruction error comprises calculating a sum of absolute difference (SAD) of the first set of samples and the reconstructed samples.

19. The method of claim 17, wherein calculating the respective reconstruction error comprises calculating a sum of squared difference (SSD) of the first set of samples and the reconstructed samples.

20. The method of claim 14, wherein selecting the second set of MPMs based on the first plurality of reconstruction errors comprises:
sorting the first plurality of reconstruction errors in an ascending order; and
selecting one or more intra prediction modes associated with reconstruction errors that satisfy a criterion.

21. The method of claim 14, wherein the second set of MPMs comprises four intra prediction modes.

22. The method of claim 14, wherein calculating the reconstruction error comprises calculating the reconstruction error for reconstructing the first set of samples using each of the plurality of intra prediction modes excluding the first set of MPMs.

23. A video processing device, comprising:
a non-transitory memory storage comprising instructions; and
one or more processors in communication with the memory storage, wherein the one or more processors execute the instructions to:
select a second set of most probable modes (MPMs) in a plurality of intra prediction modes for intra prediction of a luma block of a video frame, the second set of MPMs comprising a predetermined number of intra prediction modes in the plurality of intra prediction modes excluding a first set of MPMs in the plurality of intra prediction modes, wherein the second set of MPMs is derived by:
constructing a first reference block of the luma block, each of the first reference block and the luma block comprising a plurality of samples, and the first reference block being different from the luma block;
determining a first set of samples in the first reference block, the first set of samples excluding samples in the luma block and having been predicted;
calculating a prediction error for performing intra prediction of the first set of samples using each of two or more intra prediction modes in the plurality of intra prediction modes excluding the first set of MPMs, thereby generating a first plurality of prediction errors corresponding to the two or more intra prediction modes, each of the first plurality of prediction errors being associated with a corresponding intra prediction mode; and
selecting the second set of MPMs based on the first plurality of prediction errors.
